(19) United States
(12) Patent Application Publication
(10) Pub. No.: US 2012/0155805 A1
(43) Pub. Date: Jun. 21, 2012

(54) MULTI-CORE OPTICAL CABLE TO PHOTONIC CIRCUIT COUPLER

(76) Inventor: Christopher Doerr, Middletown, NJ (US)

(21) Appl. No.: 12/972,667

(22) Filed: Dec. 20, 2010

(51) Int. Cl. G02B 6/34; B05D 5/06; H01P 11/00

(52) U.S. Cl. 385/37; 427/163.2

(57) ABSTRACT

An optical device includes a substrate and a plurality of three or more planar waveguides formed over the substrate. Each planar waveguide includes a corresponding grating coupler formed therein. The grating couplers are arranged in a non-collinear pattern over said substrate. The plurality of grating couplers is configured to optically couple to a corresponding plurality of fiber cores in a multi-core optical cable.

### TECHNICAL FIELD

This application is directed, in general, to an optical device.

### BACKGROUND

Integrated photonic devices (IPDs) are analogous with integrated electronic circuits, providing multiple optical functions on a single substrate. While currently relatively simple, IPDs have the potential to achieve greater integration levels. As more optical functions are integrated, an increasingly large number of optical inputs to and outputs from the IPD may be needed.

### SUMMARY

One aspect provides an optical device. The optical device includes a substrate and a plurality of three or more planar waveguides formed over the substrate. Each planar waveguide includes a corresponding grating coupler formed therein. The grating couplers are arranged in a non-collinear pattern over the substrate. The plurality of grating couplers is configured to optically couple to a corresponding plurality of fiber cores in a multi-core optical cable.

Another aspect provides a system. The system includes an optical source and a multi-core optical cable. The optical source is configured to produce a plurality of optical signals, and the optical cable is configured to receive the optical signals. The optical cable includes a plurality of optical fiber cores arranged in a core pattern. An integrated photonic device has a plurality of grating couplers. Each of the grating couplers is formed in a corresponding planar waveguide, and is configured to receive an optical signal from one of the optical fiber cores. The grating couplers are arranged in a pattern that corresponds to the core pattern of the optical cable.

Another aspect provides a method. The method includes forming three or more planar waveguides over a substrate of an optical device. A grating coupler is located within each of the planar waveguides such that the grating couplers form a non-collinear pattern over the substrate. Each grating coupler is located about 100 μm or less from an adjacent grating coupler.

### BRIEF DESCRIPTION

Reference is now made to the following descriptions taken in conjunction with the accompanying drawings, in which:

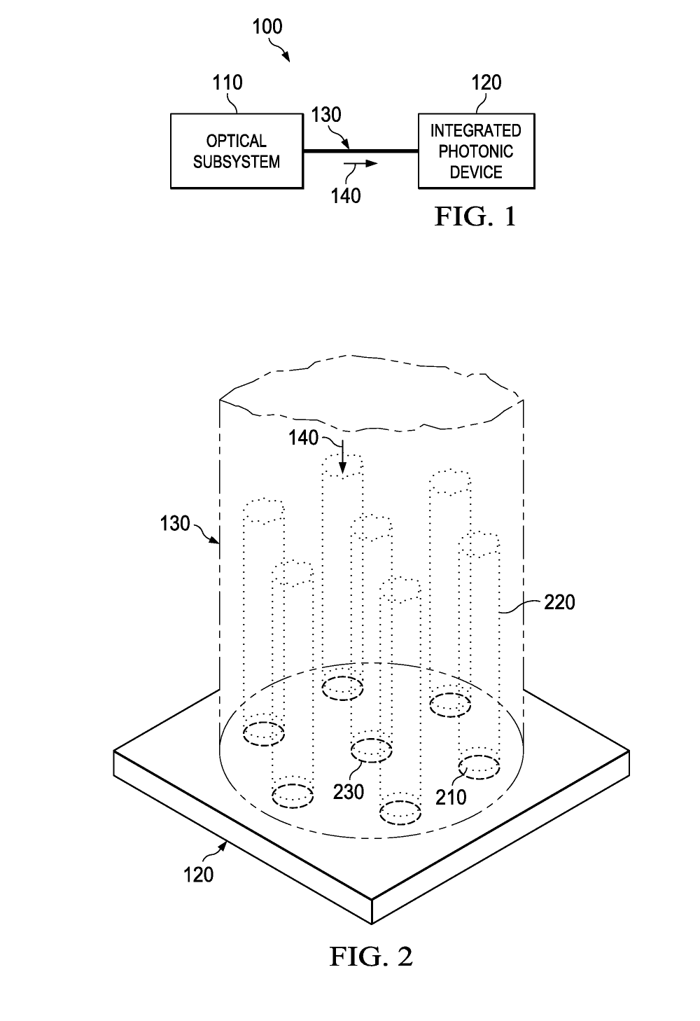

FIG. 1 illustrates an optical system including an optical source, a multi-core optical cable, and an integrated photonic device;

FIG. 2 illustrates a detail of the multi-core optical fiber cable and the IPD of FIG. 1, in which the cable is located such that fiber cores project light signals onto corresponding grating couplers of the integrated photonic device;

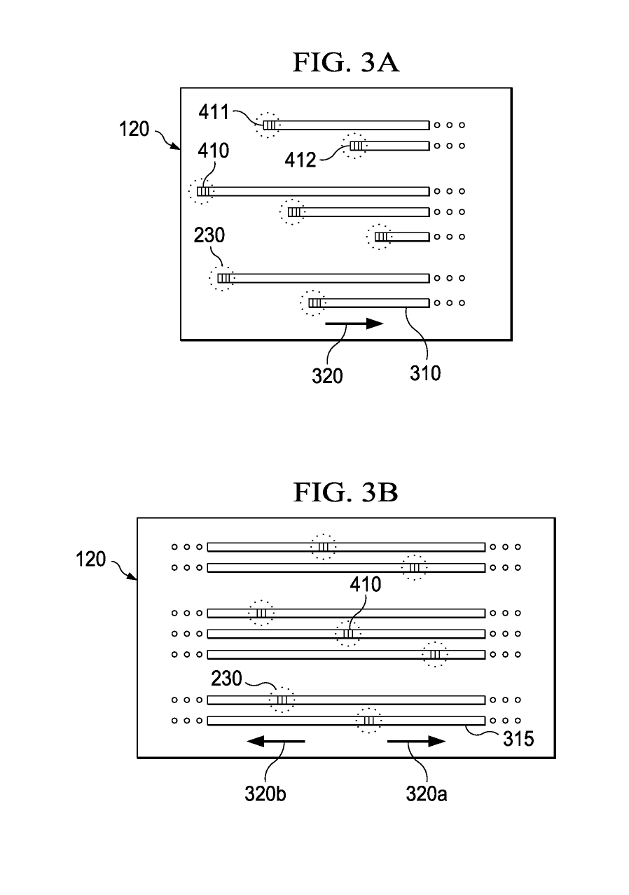

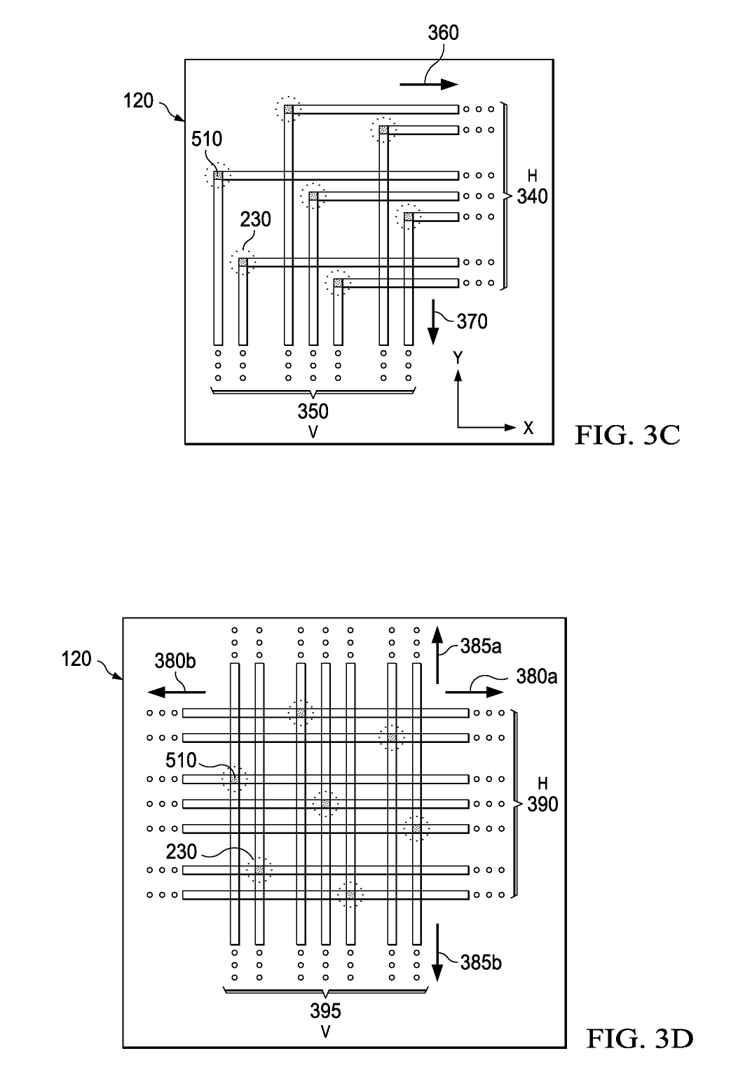

FIGS. 3A-3D illustrate embodiments of planar waveguides of the IPD and grating couplers configured to couple signals from the multi-core optical cable to the waveguides;

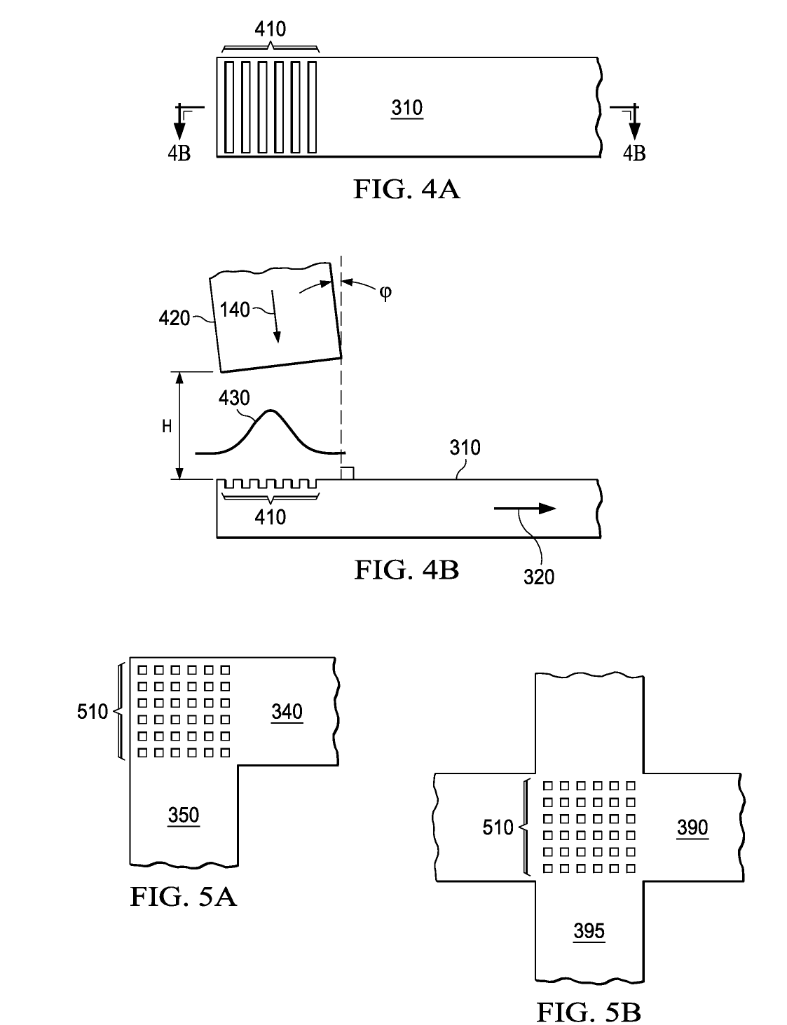

FIGS. 4A and 4B respectively provide a top and side view of a single fiber core and a 1-D pattern grating coupler of the IPD;

FIGS. 5A and 5B illustrate embodiments of a 2-D pattern grating coupler configured to couple an optical signal into X-oriented and Y-oriented waveguides;

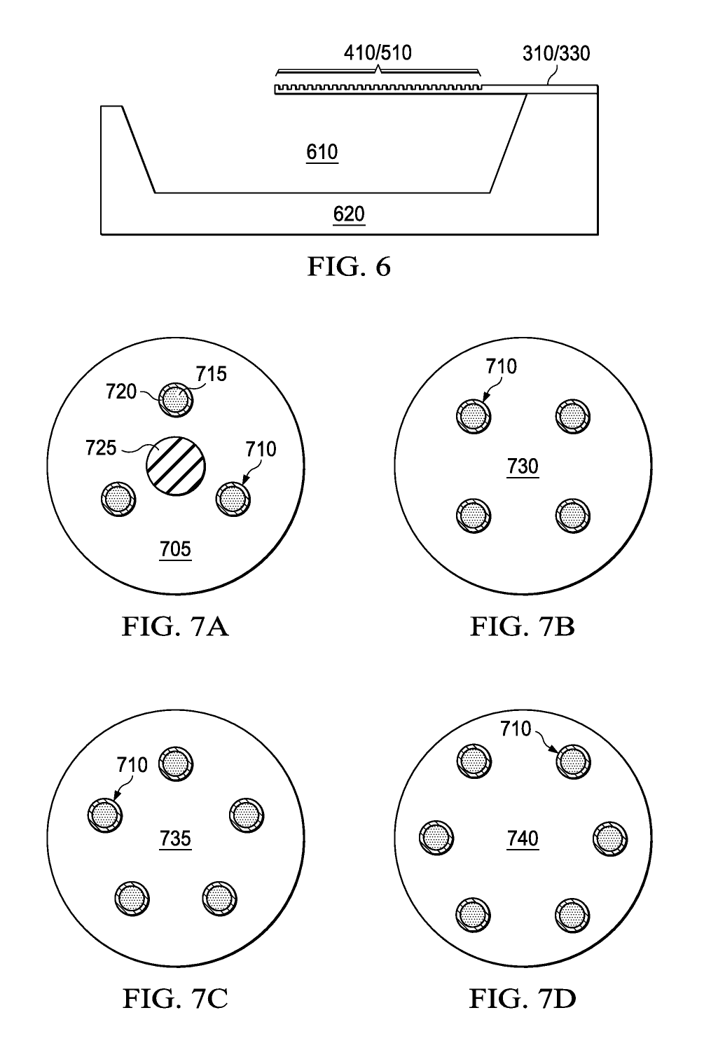

FIG. 6 illustrates an embodiment in which a cavity is located between the grating coupler and an underlying substrate;

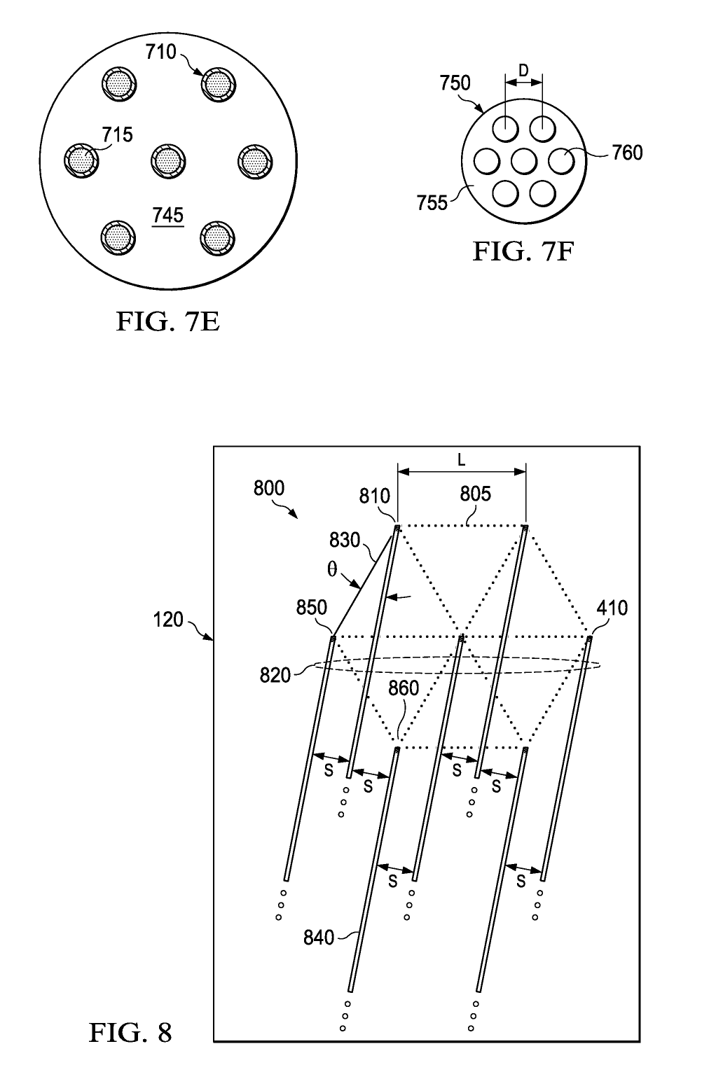

FIGS. 7A-7F illustrates various configurations of the multi-core optical cable of FIG. 1;

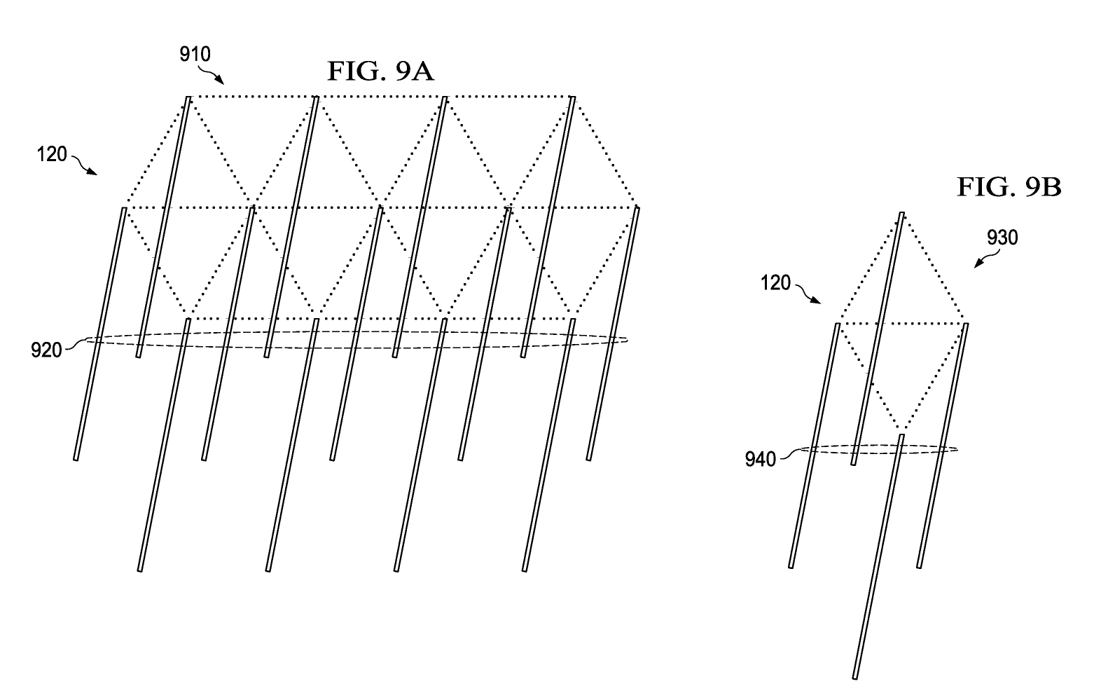

FIGS. 8, 9A and 9B illustrate embodiments of waveguide routing to grating couplers located at vertices of a regular array of triangles;

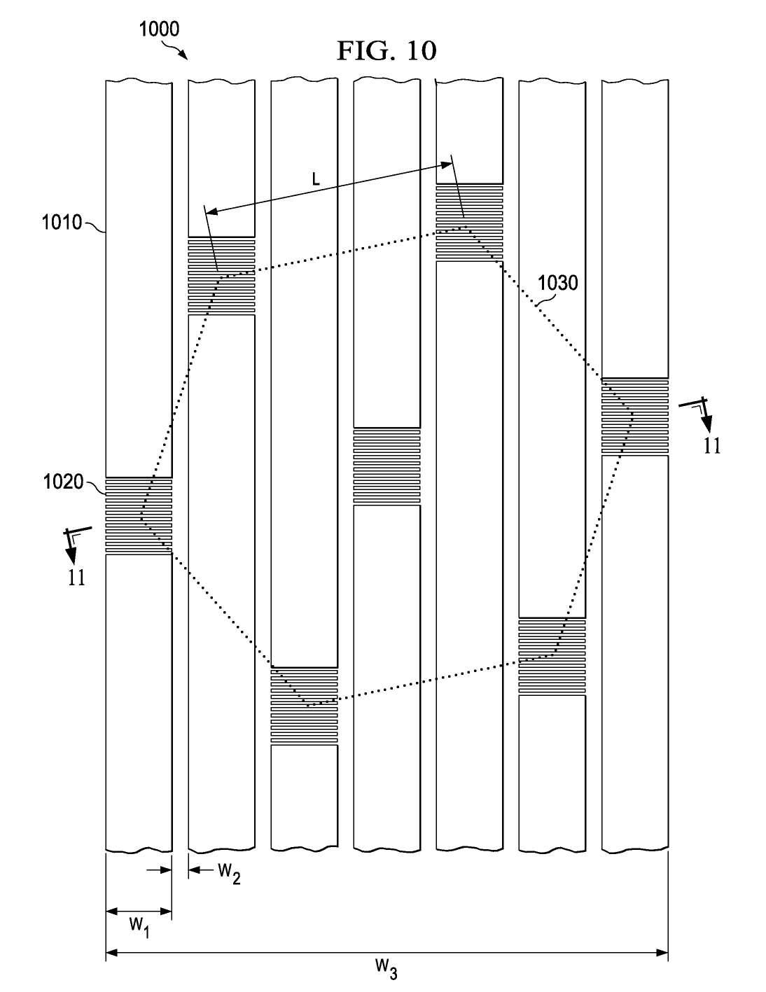

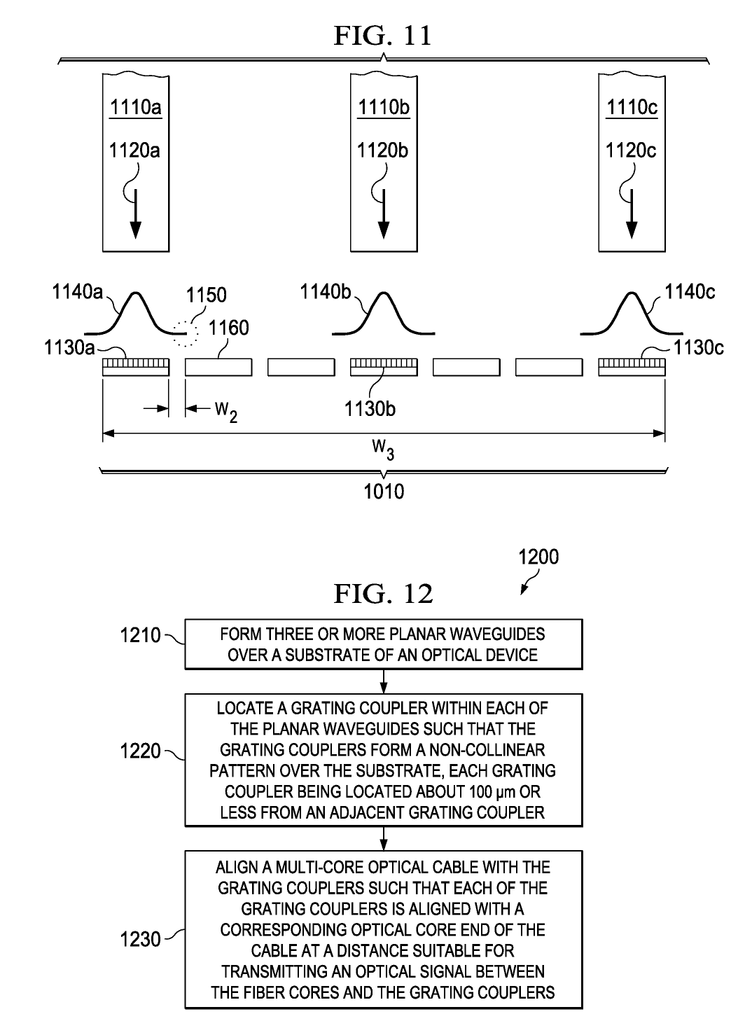

FIGS. 10 and 11 illustrate aspects of a high density layout of grating couplers and planar waveguides of the IPD of FIG. 1; and

FIG. 12 illustrates a method of forming an integrated photonic device such as that illustrated in FIG. 2.

### DETAILED DESCRIPTION

The increasing integration density of integrated photonic devices (IPDs) places demands on optical connections to the IPD that cannot be easily met by conventional connectors. In some cases, an IPD may be no larger than a few millimeters, e.g. 2-5 mm or less, on a side, and may require several optical signals delivered via individual fiber cores. Herein, a “fiber core” may be briefly referred to as a “core” without loss of generality. In conventional practice, one or more optical fibers, each carrying an optical carrier, typically are separately brought close to the surface of the IPD to project the signal to a coupler. The one or more fibers are typically held in place by a silicon V-groove assembly. The V-groove assembly may have multiple potential failure modes, and may be bulky compared to the IPD dimensions, therefore providing for only a few optical fibers to be routed to the IPD. Moreover, a V-groove assembly typically holds multiple fibers in a linear pattern, so does not make effective use of available area on the IPD. Furthermore, individual optical fibers held by the V-groove assembly are typically separated from each other by a distance that is substantial at the scale of an IPD, typically on a 127 μm or 250 μm pitch.

Embodiments herein address the need to provide multiple optical signals to an optical device by providing methods, devices and systems configured such that the optical signals are routed to the optical device via a high multi-core optical cable or a multi-core fiber. Herein and in the claims the term “multi-core optical cable”, or MCOC, includes multi-core fibers that include at least two fiber cores capable of carrying separate optical carriers therein, and cables that bundle at least two discrete optical fibers within a cable assembly. As described herein below, optical couplers on the IPD are located to match a pattern of fiber cores at the end of a suitably prepared MCOC. The MCOC may be aligned to an IPD using a single alignment mechanism such that individual cores are aligned with their associated couplers. In this manner a high density optical I/O port may be achieved at low cost, and points of potential failure may be reduced.

Turning initially to FIG. 1, illustrated is an optical system 100. The system 100 includes an optical subsystem 110 and an IPD 120. An MCOC 130 links the subsystem 110 and the IPD 120. The MCOC 130 may provide unidirectional or bidirectional communication between the subsystem 110 and the IPD 120. The subsystem 110 includes a plurality of optical sources, e.g. lasers, and modulation systems configured to modulate the optical sources with data. Such modulation may include, e.g. phase, intensity and/or polarization modulation. The MCOC 130 guides a plurality of optical signals 140 between the subsystem 110 and the IPD 120. Herein any of the plurality of optical signals 140 may be referred to as an optical signal 140.

The IPD 120 includes a plurality of optical grating couplers. As described further below, in some embodiments the grating couplers are arranged in a two-dimensional (2-D) pattern on the surface of the IPD 120. In other words, in such embodiments at least three grating couplers are not arranged collinearly on the IDP 120 as they would be with a conventional optical system using a V-groove assembly. In some embodiments the array is configured such that one grating coupler is aligned with each of at least three cores of the MCOC 130. In other embodiments the array is configured such that at least two adjacent grating couplers are separated by a distance less than that possible with a conventional V-groove assembly, e.g. about 100 μm or less. In various embodiments the optical grating couplers are arranged in a pattern that matches that of the fiber cores exposed at the end of the MCOC 130.

As described previously the MCOC 130 may be a cable including several discrete optical fibers. In such embodiments the MCOC 130 may be prepared, e.g. by cutting at the desired location, and removing any burrs or debris associated with a cable jacket, fillers, etc. If needed the exposed ends of individual optical fibers may be lapped.

In other embodiments the MCOC 130 is a single cladding having multiple core regions therein having a higher refractive index than the cladding. Each core region is capable of separately transmitting an optical signal therein with little cross-talk among the multiple core regions. In such embodiments preparation of the MCOC 130 may be considerably simpler than for the multiple-fiber cable. A length of the cladding/core portion of the MCOC 130 may be isolated from any protective layers, such as a sheath, and cleaved. If desired, the end of the cladding/core portion may be lapped as well.

The number of fiber cores is not limited to any particular value. However, in the case of multiple-fiber cables, commercial cables are readily available that include 72 or more optical fibers. In the case of multiple cores embedded in a single cladding, a seven-core fiber, described in greater detail below, has been manufactured by OFS Labs, Somerset, N.J., USA.

As briefly described previously, in conventional practice individual single-core optical fibers are typically located near grating couplers of an IPD with the aid of a V-groove assembly. A V-groove assembly typically holds optical fibers in a linear array with either about a 125 μm fiber pitch or about a 250 μm fiber pitch. The pitch is typically determined by the cladding diameter of the optical fibers secured by the V-groove assembly. The cladding diameter is selected in part to provide mechanical strength to the optical fiber, and to provide desired performance characteristics of the fiber. These factors present a significant design barrier to the reduction of the pitch of the V-groove assembly below 125 μm. Thus known conventional integrated photonic devices typically do not have grating couplers spaced more closely than about 125 μm.

The mechanical bulk of the V-groove assembly results in the assembly often having a size comparable to or larger than the IPD to which the optical fibers are interfaced. As a result only one V-groove assembly typically can be used with an IPD. Accordingly known conventional IPDs are typically limited to having only a single linear array of grating couplers.

In contrast with such conventional practice, embodiments of the disclosure provide a means for using a greater number of grating couplers on the IPD 120 than previously possible, in part by placing grating couplers in a non-collinear, or 2-D, pattern. Herein and in the claims grating couplers in a non-collinear, or 2-D, pattern are arranged such that a straight line cannot be simultaneously drawn through a same reference location on the grating couplers. Thus, for example, if each grating coupler has a same rectangular perimeter, a straight line cannot be simultaneously drawn through the same corner of the rectangular perimeter of each grating coupler in the pattern.

FIG. 2 illustrates an isometric view of the IPD 120 with the MCOC 130 located proximate thereto. Fiber core ends 210 terminate individual fiber cores 220 within the MCOC 130. The MCOC 130 is illustrated without limitation as including six fiber cores 220 arranged in a hexagonal pattern around a seventh central fiber core 220. The optical signal 140 propagating within each fiber core 220 produces a spot 230 on the IPD 120. The MCOC 130 typically does not touch the IPD 120, but is located at a distance therefrom such that the beam emerging from each fiber core does not spread excessively. For example, in some embodiments the distance between the core ends 210 and the IPD 120 is in a range from about 100 μm to about 500 μm, inclusive.

FIGS. 3A-3D illustrate four embodiments of the IPD 120 configured to receive optical signals from the MCOC 130. In FIG. 3A, each spot 230 illuminates a corresponding array of 1-D pattern grating couplers 410 formed on planar waveguides 310. The planar waveguides 310 may be any conventional or novel waveguide such as a buried or ridge waveguide. Those skilled in the pertinent art are knowledgeable of methods of forming such waveguides. The waveguides 310 may be formed of any material suitable for such purposes, such as silicon, SiN, GaAs, AlGaInAs and LiNbO3. Each of the waveguides 310 includes an instance of a grating coupler 410 described below.

FIGS. 4A and 4B respectively illustrate top and side views of a single grating coupler 410 and waveguide 310. An individual fiber core 420 (FIG. 4B) is one of a plurality of similar cores within the MCOC 130. The core 420 guides the optical signal 140 to the grating coupler 410. The intensity cross section of the projected optical signal 140 is expected to closely approximate a Gaussian distribution 430. The grating coupler 410 is a linear (1-D) array of trenches and ridges formed into the associated waveguide 310. The combined width of one trench and one ridge (e.g. the grating pitch) is typically chosen to be about equal to one wavelength of the transverse electric (TE) mode in the waveguide 310 so that the scattered portions from each period of the grating add constructively in the waveguide. This typically provides effective coupling of the TE propagation mode of the waveguide 310 to the fiber mode that has its electrical field about parallel to the grooves. In some embodiments the grating pitch is about equal to one wavelength of the transverse magnetic (TM) mode in the waveguide 310. This typically provides effective coupling of the TM propagation mode of the waveguide 310 to the fiber mode that has its electrical field about perpendicular to the grooves. Light received by the grating coupler 410 is scattered and coupled to a horizontal optical signal 320 that propagates parallel to the planar waveguide 310. Once coupled to the waveguide 310 the optical signal 320 is TE polarized.

FIG. 4B illustrates the general case in which the core 420 forms an angle φ with respect to a surface normal of the waveguide 310. In some embodiments p is nonzero as illustrated. In such cases, coupling of the optical signal 140 to the waveguide 310 favors the formation of the signal 320 in a unidirectional fashion. In other embodiments φ is preferably about zero, e.g. normal to the waveguide 310. Such an embodiment is discussed further below.

Referring concurrently to FIGS. 2 and 4B, the MCOC 130 may be held in position relative to the IPD 120 by mechanical means that may be determined by one skilled in the pertinent art without undue experimentation. Such means may include a V-groove assembly and a positioning mechanism that permits three-axis translation and rotation of the MCOC 130 such that the core ends 210 may be positioned with respect to height H and position above the IPD 120, and aligned with, e.g. the grating couplers 410.

Returning to FIG. 3A, the previously described example of seven fiber cores 220 within the MCOC 130 is continued. Each fiber core 220 projects a corresponding spot 230 onto a corresponding grating coupler 410. The spots 230 are illustrated as having an area larger than the grating couplers 410, but may have an area comparable to or smaller than the grating coupler 410. The grating couplers 410 are advantageously placed at locations corresponding to the locations of the core ends 210 to receive the optical signal 140 within the corresponding fiber core 220. It may be preferred to locate the grating couplers 410 such that a peak of the Gaussian distribution 430 falls at about a geometric center of each grating coupler 410. The grating coupler 410 may simultaneously act as a fiber coupler and an integrated spot-size converter. The received optical signals, e.g. the signal 320, propagate in the direction of the planar waveguides 310.

Because the MCOC 130 end is brought directly to the IPD 120 surface, the grating couplers 410 may be closer than provided by conventional practice. In some embodiments, e.g. one grating coupler, e.g. a grating coupler 411, is located about 100 μm or less from an adjacent (e.g. next-nearest) grating coupler, e.g. a grating coupler 412. In some cases the separation of adjacent grating couplers is about 50 μm or less. In some embodiments, as described further below, the separation of adjacent grating couplers is about 38 μm. Because of the aforementioned design barrier to reducing fiber pitch in a V-groove assembly, reduction of the distance between grating couplers to about 100 μm or less in present embodiments represents a significant advance in optical I/O to a photonic device.

FIG. 3B illustrates an embodiment in which the waveguides 310 extend in two directions along a single axis from the grating couplers 410. It may be preferable in such cases that the core 220 be positioned about normal to the waveguide 310, e.g. (φ≈0. In this case the optical signal 140 may be split evenly between oppositely directed components. Thus, a right hand signal 320a and a left hand signal 320b coupled to the waveguide 310 may have about equal intensity. The signals 320a, 320b may be recombined if desired or processed separately on the IPD 120.

FIG. 3C illustrates an embodiment of the IPD 120 in which 2-D pattern grating couplers 510, described below, are configured to couple the optical signal 140 to an “X” component and a “Y” component, as referenced by an illustrative coordinate axis. The optical signal 140 may be arbitrarily polarized with respect to horizontal waveguides 340 and vertical waveguides 350. X components 360 are directed to the horizontal waveguides 340 while Y components 370 are directed to vertical waveguides 350. The waveguides 340, 350 are unidirectional, in that they respectively extend only in one direction along the illustrated coordinate x and y axes.

FIG. 3D illustrates a similar embodiment in which the grating couplers 510 respectively direct X components 380a, 380b and Y components 385a, 385b to bidirectional horizontal waveguides 390 and bidirectional vertical waveguides 395.

FIG. 5A illustrates the 2-D pattern grating coupler 510 for the case of FIG. 3C, e.g. in which the X and Y components of the received signal propagate unidirectionally from the grating coupler 510. The grating coupler 510 illustratively includes a regular 2-D array of pits formed at the intersection of the planar waveguides 340, 350. See, e.g. Christopher R. Doerr, et al., “Monolithic Polarization and Phase Diversity Coherent Receiver in Silicon”, Journal of Lightwave Technology, Jul. 31, 2009, pp. 520-525, incorporated herein by reference in its entirety. With respect to arrays, “regular” means each element of the array is spaced about a same distance from its neighbor element(s). The grating coupler 510 may separate X and Y components of the optical signal 140 and direct one component, e.g. X, in the direction of the waveguide 340 and another component, e.g. Y, in the direction of the waveguide 350.

In FIG. 5B the grating coupler 510 is located at an intersection of the waveguide 390 and the waveguide 395. Light from the X component of the optical signal 140 may be coupled bidirectionally into the waveguide 390. Referring back to FIG. 3D, e.g. a first component 380a may be directed to the right with respect to the figure, and a second component 380b may be directed to the left. Similarly, light from the Y component of the signal optical 140 may be coupled bidirectionally in the waveguide 395. Again referring back to FIG. 3D, a first component 385a may be directed upward and a second component 385b may be directed downward as FIG. 3D is oriented.

FIG. 6 illustrates an embodiment in which a cavity 610 is located between the grating coupler 410 or grating coupler 510 and an underlying substrate 620. Additional details of, and a method of forming, the cavity 610 are disclosed in U.S. patent application Ser. No. 12/756,166 incorporated by reference herein in its entirety. In brief summery, a wet chemical etch process may be used to remove a portion of the substrate 620 on which the waveguide, e.g. the waveguide 310 or the waveguide 340, has been formed. The presence of the cavity 610 reduces the refractive index below the grating coupler 410 relative to the case in which the cavity is not present. In some circumstances the lower refractive index increases coupling efficiency between an optical signal projected onto the grating coupler 410 and the waveguide 310, or a signal coupled from the waveguide 310 to the grating coupler 410.

FIGS. 7A-7F illustrate six example configurations of fiber cores in a multi-core configuration. FIG. 7A illustrates an MCOC 705 that includes three individual optical fibers 710. The MCOC 705 may be, e.g. a multicore fiber cable. Each optical fiber 710 includes a core 715 and a cladding 720. The optical fibers 710 are arranged around a strain relief 725 that is illustrative of nonoptical components that may be present within the MCOC 705, including packing or filler materials. FIGS. 7B-7E respectively illustrate MCOCs 730, 735, 740, 745 respectively having four, five, six and seven optical fibers 710. The number of fibers within an MCOC is not limited to any particular number.

In each of the MCOCs 705, 730, 735, 740, 745 the fiber cores 715 are arranged in a 2-D pattern, e.g. a straight line cannot be drawn through each of the cores 715. Thus when the grating couplers 410, 510 are arranged to match the locations of the fiber cores 715, the grating couplers are also arranged in the 2-D pattern. The minimum distance between the fiber cores 715 will depend in part on the thickness of the cladding 720 and the presence and form of any sheath or other components between the optical fibers 710. In each case an embodiment of the IPD 120 may be configured to have the grating couplers 410 or grating couplers 510 arranged thereon in a pattern that corresponds to the pattern of optical fibers 710, or more specifically the fiber cores 715, within the corresponding multicore cable.

FIG. 7F illustrates an embodiment in which an MCOC 750 is a multicore fiber. As understood by those skilled in a pertinent art, a multicore fiber is a fiber having a cladding region that is common to a plurality of core regions. Because the core regions do not each have a separate cladding or sheath, the core regions may be spaced more closely than separate cores may be placed in a single optical cable. For example, the MCOC 750 includes a cladding region 755 and core regions 760. The illustrated embodiment includes seven core regions, but embodiments are not limited to any particular number of core regions 760. A distance D is the distance from the center of one core region 760 to the center of an adjacent core region 760. While D is not limited to any particular value, in some embodiments D is preferably about 100 μm or less and more preferably about 50 μm or less. For example, the OFS Labs multi-core fiber described above is reported to have a center-to-center spacing of about 38 μm between nearest neighbor fiber cores. In the illustrated configuration the centers of the core regions 760 are located at the vertices of a regular array of triangles, e.g. equilateral triangles. The seven core regions 760 are located such that the core ends 210 are located at the center and vertices of a regular hexagon, e.g. a hexagon for which the sides have about equal length and the vertices have about a same angle.

FIG. 8 illustrates an embodiment 800 of the IPD 120 configured to receive light from seven fiber cores, such as the fiber cores 760, located at vertices of an equilateral triangular lattice 805 with sides having length L. The lattice is indicated by dashed lines between vertices for reference. Grating couplers 810 are located at the vertices. The center-center distance (also L) between the grating couplers 810 may be the distance between fiber cores, such as for the cores 715 or the cores 760. In some embodiments L may be about 50 μm or less, and may be about 38 μm. Thus, in one embodiment the MCOC 750 may be brought close, e.g. 100 μm to 500 μm, to the array of grating couplers 810 to simultaneously project signals carried by the core regions 760 within the MCOC 750 onto each of the seven grating couplers 810.

In an embodiment the planar waveguides 820 are configured so that they are parallel and equally spaced, e.g. by a distance S. The waveguides 820 form an angle θ with respect to a line 830 drawn between a first grating coupler 810, and a next-nearest grating coupler 850 as illustrated. The angle θ may be determined to be equal to about

$$\frac{π}{3} - {tan}^{- 1} \frac{\sqrt{3}}{2} ,$$

or about 19°. In some cases it is preferred that θ is 19°±2°, with 19°±1° being preferred. When arranged in this manner the waveguides 820 are about equally spaced from the grating couplers 810. For example, a waveguide 840 is equidistant from the grating coupler 850 and a grating coupler 860 at the points of closest approach. Thus the interaction of each projected spot, e.g. the spots 230, with adjacent waveguides 820 will be minimized and about equal. The illustrated arrangement advantageously provides a compact and regular configuration of the waveguides 820 and the grating coupler 810.

In some embodiments, an MCOC such as the MCOC 130 may be tilted with respect to the surface of the IPD 120 to favor unidirectional coupling into the waveguides 820. One such embodiment is illustrated in FIG. 4B, for example. In particular such coupling of a particular fiber core within the MCOC is advantageously favored when that fiber core is tilted in a plane perpendicular to the IPD 120 surface and parallel to an associated waveguide 820. When the MCOC is tilted the resulting light spot projected onto the IPD 120 is stretched into an ellipse. Referring to FIG. 4B, the major axis of the ellipse is stretched by about a factor of about 1/cos(φ). In various embodiments the grating coupler, e.g. a grating coupler 410, 510, may be elongated in the direction of the major axis of the projected ellipse to capture light that might otherwise fall outside the extent of the grating coupler. The elongation of the grating coupler may also be by about a factor of about 1/cos(φ).

While the embodiment 800 provides a particularly compact arrangement of grating couplers 810, other embodiments having more relaxed dimensions are possible and contemplated. For example, referring back to FIG. 7E, the MCOC 745 has seven optical fibers 710 arranged in hexagonal pattern similar to that of the MCOC 750. However, the minimum distance between the fiber cores 715 in the MCOC 745 is significantly greater than that of the MCOC 750. Thus, while an array of the grating couplers 410 may be arranged to correspond to the pattern of fiber cores 715 in the MCOC 745, the arrangement will not be as compact as the array that corresponds to the core regions 760 of the MCOC 750.

The compactness of the embodiment 800 provides a means to provide a high-density optical I/O port to the IPD 120. The length L may be reduced to the limit supported by the minimum width and spacing of the waveguides 310 and the minimum spacing between the centers of the fiber cores 715 or core regions 760. In the illustrated embodiment 800 seven fiber cores, such as the fiber cores 715 or core regions 760, form a hexagonal pattern having six equilateral triangles. Fewer or more fiber cores 420 and waveguides 310 may be used as well. Moreover, in some embodiments the pattern may be distorted in the vertical or horizontal directions of FIG. 8 to form an array of isosceles triangles and still produce at least some of the benefit of the equally-spaced waveguides 820. It is specifically noted, however, that while a triangular or hexagonal pattern of fiber cores 420 and grating couplers 410, 510 is advantageous in some cases, the disclosure is not limited to any particular 2-D pattern arrangements of the fiber cores 420 or the grating couplers 410, 510.

FIGS. 9A and 9B illustrate two alternate embodiments of compact optical I/O ports illustrated in schematic form to highlight the geometric arrangements of elements. In FIG. 9A, an optical I/O port 910 includes 13 grating couplers, e.g. the grating couplers 410 at vertices of the illustrated triangles. Thirteen equally spaced waveguides 920 carry received optical signals from the grating couplers 410. In another example illustrated by FIG. 9B, an optical I/O port 930 includes four grating couplers 410 at vertices of the illustrated triangles and four corresponding equally spaced waveguides 940.

FIG. 10 illustrates an optical I/O port 1000 drawn to approximate relative scale. Seven bidirectional waveguides 1010 receive seven corresponding optical signals via seven grating couplers 1020. A hexagon 1030 is provided for reference. The hexagon 1030 is rotated with respect to the vertical direction of the figure such that the waveguides 1010 are vertical. The waveguides 1010 have a width W₁ that is related to the wavelength of the optical carrier of the received signals. For example, when the carrier wavelength is about 1.5 μm, W₁ may be about 10 μm. Each waveguide 1010 is separated from its neighbor by a space W₂. The minimum value of W₂ may be related to a minimum dictated by processing limitations, or to ensure that no more than small cross-over of a signal occurs from one waveguide 1010 to a neighboring waveguide 1010. An aspect of cross-over that may be significant in some cases is the extent to which the light beam that emerges from the fiber ends diverges.

This latter point is illustrated by FIG. 11, which is a section taken through the I/O port 1000. Optical fibers 1110a, 1110b, 1110c guide optical signals 1120a, 1120b, 1120c to corresponding grating couplers 1130a, 1130b, 1130c. The intensity of the spot formed by each optical signal 1120a, 1120b, 1120c may be approximated by Gaussian distributions 1140a, 1140b, 1140c. Focusing on the Gaussian 1140a, the light may spread after the optical signal 1120a emerges from the fiber 1110a such that a tail portion 1150 overlaps a neighboring waveguide 1160. The overlapping tail portion 1150 may couple some light from the optical signal 1120a to the waveguide 1160, thereby increasing noise on a data channel carried by the waveguide 1160. The spacing W₂ between the waveguides 1010 may be limited by a minimum value such that such noise remains below a maximum allowable value.

Returning to FIG. 10, in one nonlimiting example the length L is about 38 μm and the space W₂ is about 2.5 μm. Thus a total width W₃ of the I/O port 1000 in this case is about 85 μm. In marked contrast, conventionally coupling seven fiber cores using a conventional linear array of V-grooves with a pitch of 127 um would require a total width of about 762 um. Thus I/O port 1000 uses only about one tenth the linear extent of the conventional implementation. The I/O port 1000 will therefore, among other advantages, cause significantly less interference with layout of optical components, such as waveguides and couplers, on the IPD 120.

Turning to FIG. 12, a method 1200 is presented of manufacturing an optical device, e.g. the IPD 120. The method 1200 is described without limitation with reference to the IDP 120 and components described in FIGS. 2-11. The steps of the method 1200 may be performed in another order than the order shown.

In a step 1210 three or more planar waveguides are formed over a substrate of an optical device. The substrate may be, e.g. the substrate on which the IPD 120 is formed. In some cases the substrate is no larger than about 2 mm on a side. The planar waveguides may be configured to propagate received optical signals in the course of performing an optical operation such as frequency mixing or conversion.

In a step 1220 a grating coupler is located within each of the planar waveguides such that the grating couplers form a non-collinear pattern over the substrate, and each of the grating couplers is located about 100 μm or less from an adjacent grating coupler. The grating couplers may be, e.g. the grating couplers 410 or grating couplers 510, and may be formed by conventional techniques. The non-collinear pattern may correspond to a pattern of fiber cores within a multi-core optical cable such as the MCOC 130. The multi-core optical cable may be aligned with the grating couplers such that each fiber core of the cable is located over a corresponding one of the grating couplers.

The pattern may optionally include a regular array of triangles, with the grating couplers located at vertices of the triangles. Optionally the triangles are equilateral triangles. Optionally one each of six grating couplers is located at vertices of a regular hexagon, and a seventh grating coupler is located at the center of the hexagon.

In an optional step 1230 a multi-core optical cable is aligned with the grating couplers such that each fiber core therein is located over a corresponding one of the grating couplers. Optionally the cable is a multi-core fiber such as the multi-core optical cable 750.

Those skilled in the art to which this application relates will appreciate that other and further additions, deletions, substitutions and modifications may be made to the described embodiments.

What is claimed is:

1. An optical device, comprising:
a substrate;
a plurality of three or more waveguides formed over said substrate; and
a plurality of three or more grating couplers arranged in a non-collinear pattern, each of said grating couplers being formed in a corresponding one of said waveguides, and said plurality of grating couplers being configured to optically couple to a corresponding plurality of fiber cores in a multi-core optical cable.

2. The optical device as recited in claim 1, wherein each of said grating couplers is separated from an adjacent one of said grating couplers by about 100 μm or less.

3. The optical device as recited in claim 1, wherein said grating couplers are 2-D pattern gratings.

4. The optical device as recited in claim 1, wherein each of said grating couplers is located about at an end of a respective one of said waveguides.

5. The optical device as recited in claim 1, wherein said grating couplers are configured to separate horizontal and vertical components of received optical signals.

6. The optical device as recited in claim 1, wherein said grating couplers are located about at vertices of a regular array of triangles.

7. The optical device as recited in claim 6, wherein said waveguides form an angle of about 19° with respect to a line drawn between two adjacent grating couplers.

8. The optical device as recited in claim 1, wherein a first grating coupler of said pattern is located 50 μm or less from a second grating coupler of said pattern.

9. A system, comprising:
an optical source configured to produce a plurality of optical signals;
a multi-core optical cable that includes a plurality of optical fiber cores arranged in a core pattern, said optical fiber cores being configured to receive said optical signals; and
an integrated photonic device having a plurality of grating couplers, each of said grating couplers being formed in a corresponding planar waveguide and being configured to receive an optical signal from one of said optical fiber cores, said grating couplers being arranged in a pattern that corresponds to said core pattern.

10. The system as recited in claim 9, wherein said grating couplers are 2-D pattern grating arrays.

11. The system as recited in claim 9, wherein each of said grating couplers is located at an end of a respective one of said waveguides.

12. The system as recited in claim 9, wherein said grating couplers are configured to separate horizontal and vertical components of received optical signals.

13. The system as recited in claim 9, wherein said grating couplers are located at vertices of a regular array of triangles.

14. The system as recited in claim 13, wherein said waveguides form an angle of about 19° with respect to a line between two adjacent grating couplers.

15. The system as recited in claim 9, wherein a first grating coupler of said pattern is located about 50 μm or less from a second grating coupler of said pattern.

16. A method, comprising:
forming three or more planar waveguides over a substrate of an optical device;
locating a grating coupler within each of said planar waveguides such that said grating couplers form a non-collinear pattern over said substrate, each grating coupler being located about 100 μm or less from an adjacent grating coupler.

17. The method as recited in claim 16, further comprising aligning a multi-core optical cable with said grating couplers such that each fiber core of said cable is located over a corresponding one of said grating couplers.

18. The method as recited in claim 17, wherein said cable is a multicore fiber.

19. The method as recited in claim 16, wherein said pattern is a regular array of triangles, with said grating couplers located at vertices of the triangles.

20. The method as recited in claim 16, wherein said pattern includes a regular hexagon.
